(19) United States
(12) Patent Application Publication
(10) Pub. No.: US 2018/0335876 A1
(43) Pub. Date: Nov. 22, 2018

(54) BUILT-IN TOUCH PANEL AND DISPLAY DEVICE

(71) Applicant: Wuhan China Star Optoelectronics Technology Co., Ltd., Wuhan, Hubei (CN)

(72) Inventors: Chunqian Zhang, Wuhan, Hubei (CN); Chao Wang, Wuhan, Hubei (CN); Gui Chen, Wuhan, Hubei (CN)

(73) Assignee: Wuhan China Star Optoelectronics Technology Co., Ltd., Wuhan, Hubei (CN)

(21) Appl. No.: 15/326,580

(22) PCT Filed: Dec. 29, 2016
(86) PCT No.: PCT/CN2016/112877

§ 371 Date: Nov. 22, 2017

(30) Foreign Application Priority Data
Dec. 26, 2016 (CN) 201611217379.7

(51) Int. Cl. G06F 3/041; G02F 1/1333; G02F 1/1335; G02F 1/1337; G02F 1/1339

(52) U.S. Cl. CPC G06F 3/0412; G02F 1/13338; G02F 2001/13398; G02F 1/1337; G02F 1/13394; G02F 1/133512

(57) ABSTRACT

The technical field of liquid crystal display panels is related to, and an in-cell touch panel is provided. The in-cell touch panel includes a first substrate, a conductive line, an alignment film, a spacer, and a second substrate sequentially from bottom to top, and further includes a black matrix covering the conductive line. Without changing a total contact area between a first contact surface of the spacer and the conductive line, the spacer can be arranged to completely stand on the conductive line by changing a shape of the first contact surface. When the panel is made thinner or is pressed, contact and friction between the spacer and the alignment film around the conductive line can be avoided, and large-area non-uniform liquid crystal alignment can be avoided. An area of the black matrix arranged around the spacer can be greatly reduced, and accordingly an aperture ratio of pixels can be improved.

### CROSS-REFERENCE TO RELATED APPLICATIONS

The present application claims the priority of Chinese patent application CN201611217379.7, entitled “In-cell touch panel and display device” and filed on Dec. 26, 2016, the entirety of which is incorporated herein by reference.

### FIELD OF THE INVENTION

The present disclosure relates to the technical field of liquid crystal display panels, in particular to an in-cell touch panel and a display device in which non-uniformity of an image during display can be reduced.

### BACKGROUND OF THE INVENTION

An in-cell touch panel refers to a touch panel in which touch function is embedded into liquid crystal pixels, and the in-cell touch panel has a smaller thickness compared with a traditional on-cell liquid crystal display panel.

FIG. 1 is a sectional view of an existing liquid crystal display panel, which generally includes a first substrate, a second substrate, and a liquid crystal layer (not shown in FIG. 1) filled between the first substrate and the second substrate. It can be seen from FIG. 1 that, the liquid crystal display panel comprises a first substrate 1, a second substrate 2, an alignment film 3, a conductive line 4 and a spacer 5. A thickness of the liquid crystal display panel depends on the spacer 5, and further the response time and picture contrast of the display performances depend on the thickness of the display panel. As shown in FIG. 1, a first contact surface of the spacer 5 is larger than a top surface of the conductive line 4 in area, and due to the smaller thickness of the conductive line 4, friction between a left side or a right side of the spacer 5 and the alignment film 3 is possibly caused when the panel is touched or pressed in use, and non-uniform liquid crystal alignment is caused. Therefore, large-area black matrix for coverage is arranged around the spacer 5 of the first substrate or the second substrate in the prior art, and thus a pixel aperture ratio of the liquid crystal display panel is reduced.

FIG. 2 is a top view (when observing in a normal direction of the liquid crystal display panel) of the liquid crystal display panel in the prior art as shown in FIG. 1. It can be seen from the top view that, the large-area black matrix 6 is arranged around a main spacer 51 and an auxiliary space 52, and the aperture ratio of pixels is reduced.

In an existing in-cell touch panel, as shown in FIG. 3, a conductive line 40 located below a spacer 50 is directly disconnected to enable the spacer 50 to be directly in contact with a first substrate and prevent friction between the spacer 50 and an alignment film. However, with this arrangement, spacer density will be reduced, and the thickness of the liquid crystal display panel will also be affected. A top view of panel with this arrangement is shown in FIG. 3.

### SUMMARY OF THE INVENTION

With respect to the technical problem that large-area black matrix is arranged around the spacer in an in-cell touch panel and further the aperture ratio of pixels is affected, the present disclosure provides an in-cell touch panel. Meanwhile, due to the fact that the spacer of the in-cell touch panel provided herein is arranged on a conductive line, a spacer density is not affected, and a thickness of a liquid crystal display panel is not affected.

The in-cell touch panel provided by the present disclosure comprises a first substrate, a conductive line, a black matrix, a spacer, and a second substrate. The first substrate and the second substrate are arranged facing each other. The conductive line is arranged on a surface of the first substrate facing the second substrate. A first contact surface of the spacer abuts against the conductive line, and a second contact surface of the spacer abuts against the second substrate. A first projection is located inside the conductive line, and the first projection is a projection of the first contact surface on the conductive line. A second projection covers the conductive line, and a boundary of the second projection is parallel to a boundary of the conductive line. The second projection is a projection of the black matrix on the first substrate.

The in-cell touch panel further comprises an alignment film. The alignment film is arranged on the surface of the first substrate facing the second substrate, and the alignment film is disconnected at the conductive line.

In the in-cell touch panel provided by the present disclosure, a structure the same as that of an existing liquid crystal display panel is used. Therefore, a manufacturing process of the existing liquid crystal display panel can be used, and a production efficiency of the in-cell touch panel can be improved. Meanwhile, when the projection of the first contact surface of the spacer on the conductive line is located inside the conductive line, the first contact surface of the spacer stands totally on the conductive line. Therefore, when the panel is made thinner or is pressed, the spacer will not contact the alignment film around the conductive line, and friction therebetween will not be resulted in. In this manner, large-area non-uniform liquid crystal alignment can be avoided. Only a small amount of black matrixes need to be arranged along the conductive line, and the area of the black matrix around the spacer can be greatly deceased. Or, the black matrix does not need to be arranged around the spacer, and accordingly an aperture ratio of pixels can be improved. In addition, when the spacer stands entirely on the conductive line, a spacer density will not be reduced when the panel is made thinner or is pressed, and a thickness of the liquid crystal display panel will not be affected.

As a further improvement on the present disclosure, the first projection has a rectangular shape, or the first projection has an oval shape.

These shapes are commonly used shapes in the field of liquid crystal display panel manufacturing and are very easy to achieve, which will not affect a production procedure. When the first projection is arranged to have these shapes, it can be ensured that the spacer completely stands on the conductive line under the situation that a contact area between the spacer and the conductive line does not change. Therefore, the contact and friction between the spacer and the alignment film around the conductive line can be avoided, and non-uniform liquid crystal alignment can be avoided accordingly.

Further, the first projection includes multiple same shapes. The shapes are round shapes or polygonal shapes.

With this arrangement, the spacer is formed by multiple sub-spacers. Each sub-spacer stands completely on the conductive line, and thus the spacer formed by the multiple sub-spacers stands completely on the conductive line. Each sub-spacer can be arranged to completely stand on the conductive line by decreasing an area of a first contact surface thereof, and meanwhile, the spacer can be arranged to completely stand on the conductive line through arranging a number of the sub-spacers under the situation that a total contact area between the spacer and the conductive line does not change. The contact and friction between the spacer and the alignment film around the conductive line can be avoided, and non-uniform liquid crystal alignment can be avoided accordingly.

A thickness of the conductive line of the in-cell touch panel is a first thickness.

In another embodiment of the present disclosure, the in-cell touch panel comprises a first substrate, a conductive line, a black matrix, a spacer, and a second substrate. The first substrate and the second substrate are arranged facing each other. The conductive line is arranged on the first substrate. A first contact surface of the spacer abuts against the conductive line, and a second contact surface of the spacer abuts against the second substrate. A first projection is located inside the conductive line, and the first projection is a projection of the first contact surface on the conductive line. A second projection covers the conductive line, and a boundary of the second projection is parallel to a boundary of the conductive line. The second projection is a projection of the black matrix on the first substrate.

The in-cell touch panel further comprises an alignment film. The alignment film is arranged on the first substrate and below the conductive line.

The arrangement enables an area of the first contact surface of the spacer to be larger than a design value and enables the spacer to ride on the conductive line as shown in FIG. 1. Gaps between a left side bottom surface and a right side bottom surface of the spacer and the alignment film can be increased due to thickness increase of the conductive line. When the panel is touched or pressed during use, contact and friction between the left side or the right side of the spacer and the alignment film can be avoided, and non-uniform liquid crystal alignment can be avoided accordingly. Therefore, the black matrix with a large area does not need to be arranged around the spacer, and the aperture ratio of pixels can be further improved.

The present disclosure further provides a display device, which comprises the in-cell touch panel.

As to the in-cell touch panel provided by the present disclosure, under the situation that a total contact area between the spacer and the conductive line is not changed, the spacer can be arranged to completely stand on the conductive line by changing the shape of the first projection of the first contact surface of the spacer on the conductive line. Therefore, when the panel is made thinner or is pressed, contact and friction between the spacer and the alignment film around the conductive line can be avoided, and large-area non-uniform liquid crystal alignment can be avoided accordingly. An area of the black matrix arranged around the spacer can be reduced, and accordingly the aperture ratio of pixels can be improved. Alternatively, the spacer can be arranged to ride on the conductive line by increasing the area of the first contact surface. Meanwhile, the gap between the first contact surface of the spacer which rides on the conductive line and the alignment film can be increased by increasing the thickness of the conductive line, so that the contact and friction between the spacer and the alignment film around the conductive line can be avoided, and the large-area non-uniform liquid crystal alignment can be avoided. The area of the black matrix arranged around the spacer can be reduced, and further the aperture ratio of the pixels can be improved. Meanwhile, with this arrangement, the spacer density will not be reduced, and the thickness of the liquid crystal display panel will not be affected.

### BRIEF DESCRIPTION OF THE DRAWINGS

The present disclosure will be illustrated in detail hereinafter with reference to the embodiments and the accompanying drawings. In the drawings:

FIG. 1 is a sectional view of a liquid crystal display panel in the prior art;

FIG. 2a schematically shows a positional relationship between a spacer and a black matrix of a liquid crystal display panel in the prior art when observing in a normal direction of the panel;

FIG. 2b is an abbreviated drawing of FIG. 2a;

FIG. 3a schematically shows a positional relationship between a spacer and a black matrix of an in-cell touch panel in the prior art when the panel is observed in a normal direction thereof;

FIG. 3b is an abbreviated drawing of FIG. 3a;

FIG. 4a schematically shows an in-cell touch panel provided by the present disclosure, in which a first projection of a first contact surface of a spacer on a conductive line has a rectangular shape;

FIG. 4b is an abbreviated drawing of FIG. 4a;

FIG. 5a and FIG. 5b are diagrams when the first projection in FIG. 4 has a long round shape or an oval shape;

FIG. 6a schematically shows an in-cell touch panel provided by the present disclosure, in which a first projection of a first contact surface of a spacer on a conductive line has multiple rectangular shapes;

FIG. 6b is an abbreviated drawing of FIG. 6a;

FIG. 7 is a diagram when the first projection in FIG. 6a has multiple round shapes;

FIG. 8 is a sectional view of part of a panel according to embodiment 1;

FIG. 9a is a top view of a first contact surface and a second contact surface of a spacer of an in-cell touch panel provided by the present disclosure when a thickness of a conductive line is increased;

FIG. 9b is an abbreviated drawing of FIG. 9a; and

FIG. 10 is a sectional diagram of a structure as shown in FIG. 9a.

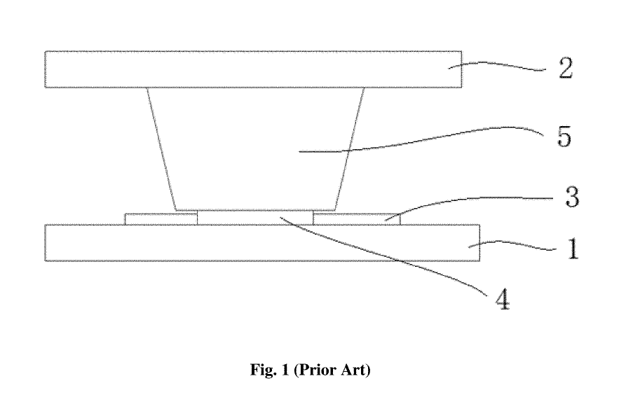

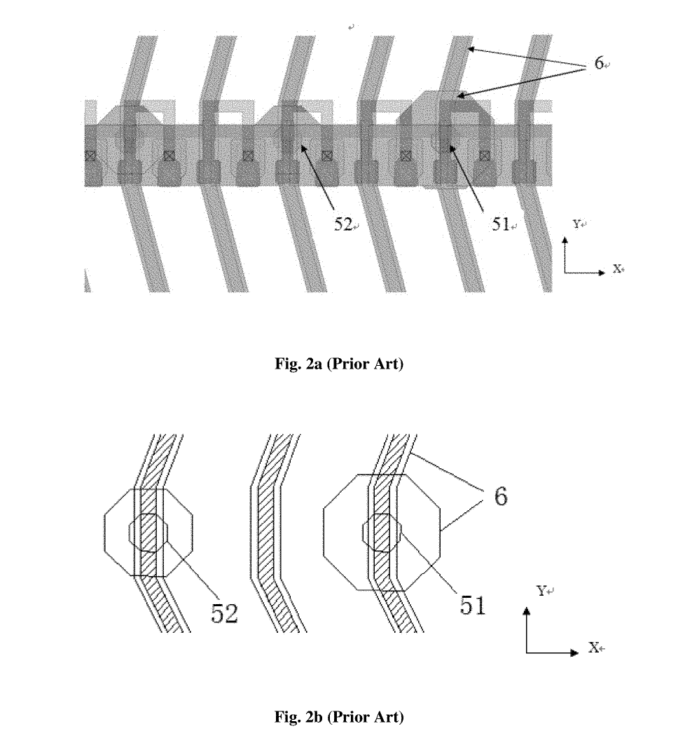

In the drawings, the same components are represented by the same reference signs, and the size of each component does not represent the actual size of the corresponding component.

### DETAILED DESCRIPTION OF THE EMBODIMENTS

The present disclosure will be described in detail below in connection with the attached drawings.

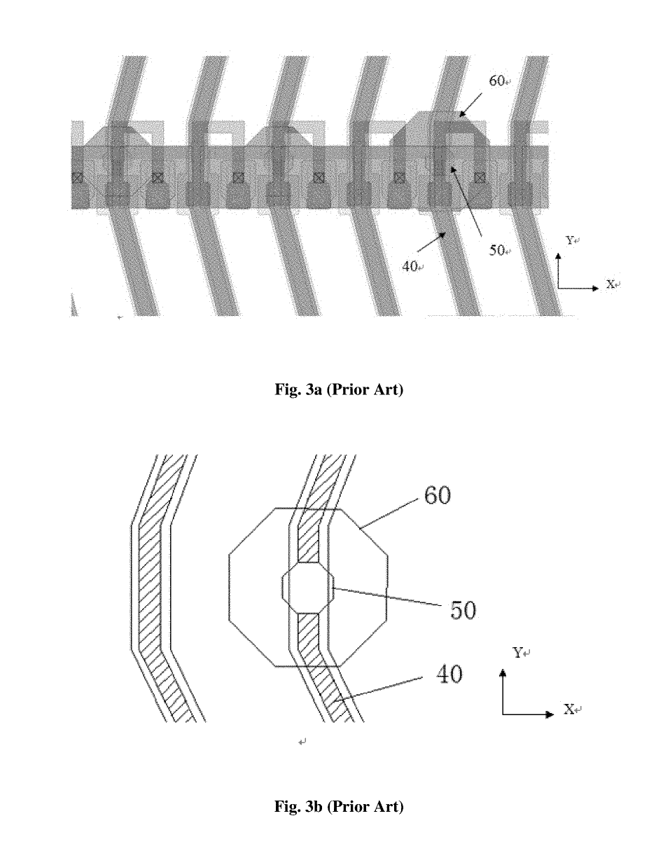

FIG. 3a shows a positional relationship between a conductive line 40 and a spacer 50 of an in-cell touch panel in the prior art. The conductive line 40 is disconnected at the spacer 50 to prevent contact between the spacer 50 and the conductive line 40, which would cause density reduction of the spacer 50 and affect a thickness of a liquid crystal cell. In FIG. 3a, directions X and Y are respectively set. It can be seen from FIG. 3a that, in a direction X, a width of the spacer 50 is larger than that of the conductive line 40, and large-area black matrix 60 is arranged around the spacer 50 to prevent non-uniform liquid crystal alignment.

### Embodiment 1

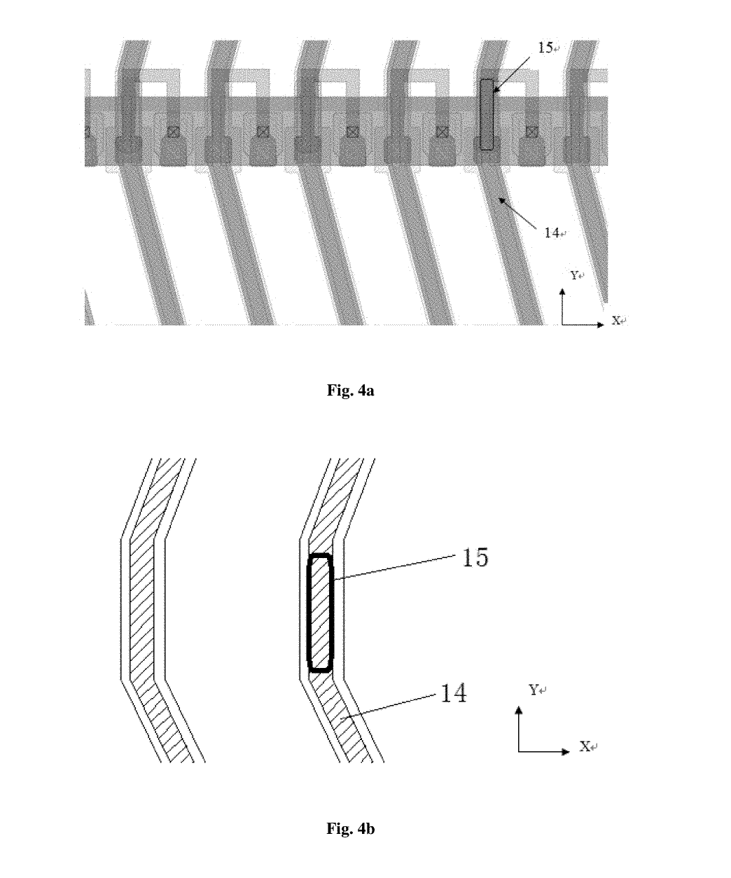

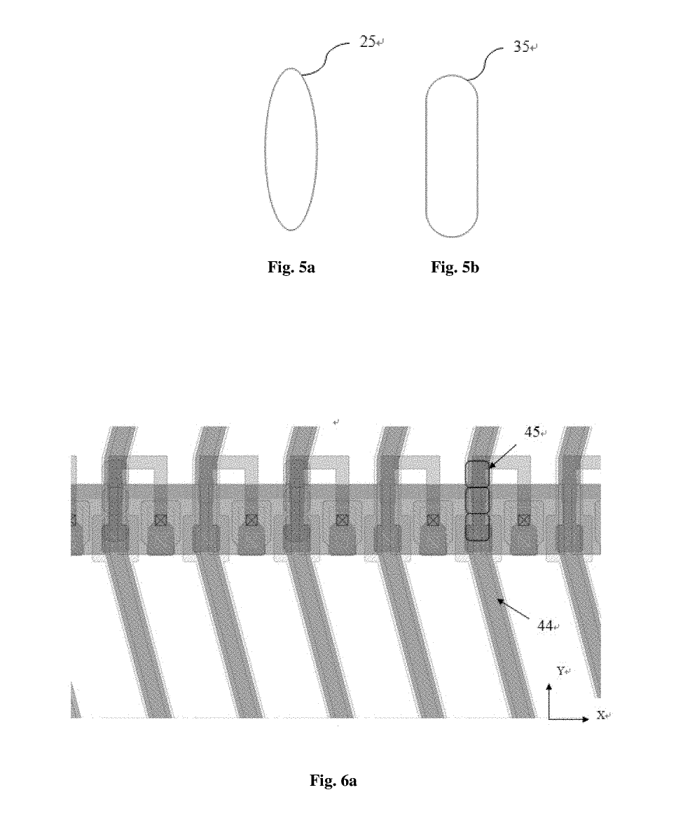

FIG. 4a schematically shows a structure of embodiment 1 of the present disclosure, and FIG. 4b is an abbreviated drawing of FIG. 4a. As shown in FIG. 4a and FIG. 4b, a first projection 15 of a first contact surface of a spacer on a conductive line 14 has a rectangular shape, and the conductive line 14 at the first projection 15 is continuous. In FIG. 4a, directions X and Y are respectively set. Along a direction X, a width of the first projection 15 is smaller than or equal to that of the conductive line 14, and the first projection 15 extends along a direction Y. Therefore, the first projection 15 is completely located inside the conductive line 14, i.e., the spacer stands completely on the conductive line 14 through the first contact surface thereof. In FIG. 4, the first projection 15 has a rectangular shape in an extending direction of the conductive line 14. Similarly, the first projection can also be arranged to have an oval shape 25 as shown in FIG. 5a or a long round shape 35 as shown in FIG. 5b. The arrangement can ensure that an area of the first projection on the conductive line 14 is the same as a design value, a supporting effect of the spacer can be ensured. Since the spacer stands completely on the conductive line 14 through the first contact surface thereof, when the panel is made thinner or is pressed, the spacer will not contact the alignment film around the conductive line 14 and friction therebetween can be avoided. Thus, large-area non-uniform liquid crystal alignment can be avoided. An area of the black matrix covered around the spacer can be greatly decreased. Comparing FIG. 3a with FIG. 4a, it can be seen that, the black matrix 60 arranged in FIG. 3a is not needed in FIG. 4a, and the aperture ratio of pixels can be improved.

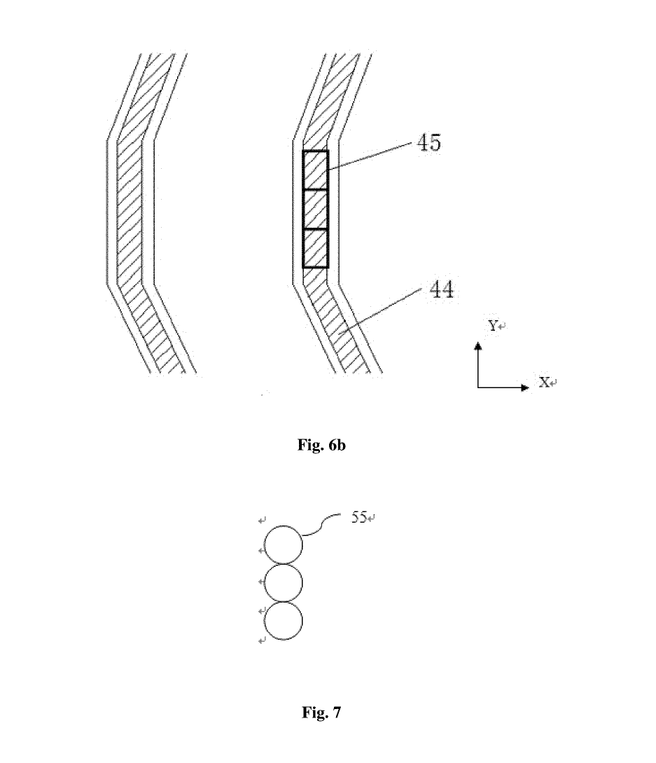

FIG. 6a is another shape of the first projection in the embodiment, and FIG. 6b is an abbreviated drawing of FIG. 6a. As shown in FIG. 6a and FIG. 6b, a first projection 45 is formed by three rectangles, and the three rectangles are sequentially arranged in an extending direction of a conductive line. That is, the spacer is formed by 3 sub-spacers with a same shape, and a first projection of a first contact surface of each sub-spacer on the conductive line is a rectangle. In the embodiment, a conductive line 44 at the first projection 45 is continuous. In FIG. 6a, directions X and Y are respectively set. Along a direction X, a width of the first projection 45 is smaller than or equal to that of the conductive line 44, and the first projection 45 is completely located on the conductive line 44. 3 sub-spacers with rectangular bottom surfaces are in sequence arranged along a direction Y. It is not hard to think that, the first projection 55 can be arranged to include three round shapes as shown in FIG. 7. That is, 3 sub-spacers with round first contact surfaces are arranged in the direction Y. The arrangement similarly ensures that the total contact area between the spacer and the conductive line 44 is equal to the design value, and a supporting effect of the spacer can be ensured. The first projection 45 can be also formed by multiple polygons in other shapes. Since the spacer completely stands on the conductive line 44, when the panel is made thinner or is pressed, contact and friction between the spacer and the alignment film around the conductive line 44 can be avoided, and large-area non-uniform liquid crystal alignment can be avoided accordingly. An area of the black matrix covered around the spacer can be greatly reduced, and an aperture ratio of pixels can be improved.

Similarly, a length of the rectangular shape or the round shape in the direction Y can be increased, so that the space is formed by 2 sub-spacers in the direction Y.

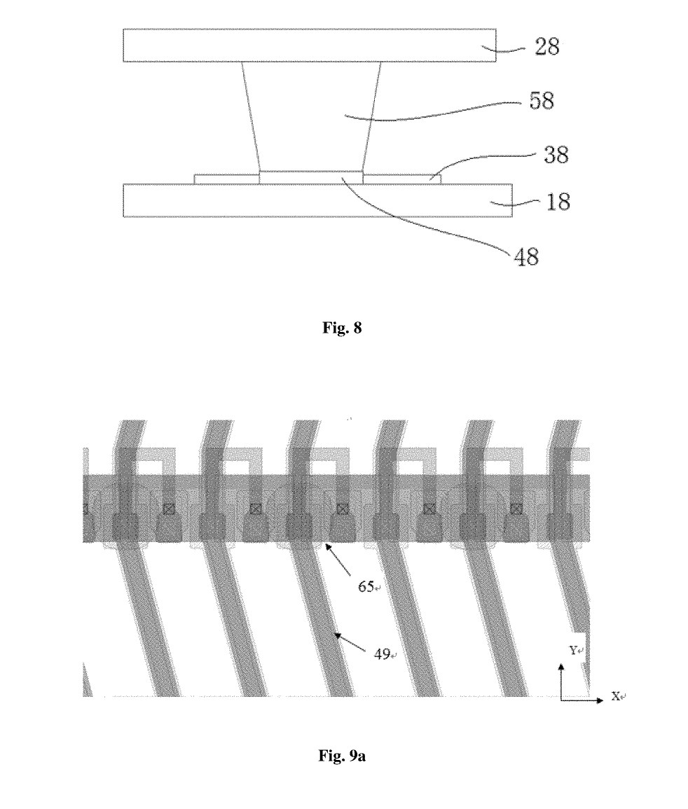

FIG. 8 is a sectional view of the structure of embodiment 1 of the present disclosure. It can be seen from FIG. 8 that, the in-cell touch panel comprises a first substrate 18, a conductive line 48, a spacer 58 and a second substrate 28. The first substrate 18 and the second substrate 28 are arranged facing each other. The conductive line 48 is arranged on a surface of the first substrate 18 facing the second substrate 28. A first contact surface of the spacer 58 abuts against the conductive line 48, and a second contact surface of the spacer 58 abuts against a surface of the second substrate 28 facing the first substrate 18. The in-cell touch panel further comprises an alignment film 38 arranged on the first substrate 18, and the alignment film 38 is disconnected at the conductive line 48. It can be seen from FIG. 8 that, the first contact surface of the spacer 58 is completely in contact with the conductive line 48. In this manner, contact and friction between the spacer 58 and the alignment film 38 can be avoided. An area of a black matrix covered around the spacer 58 of the first substrate 18 can be greatly reduced, and thus an aperture ratio of pixels can be improved. Here, a thickness of the conductive line 48 is a first thickness.

### Embodiment 2

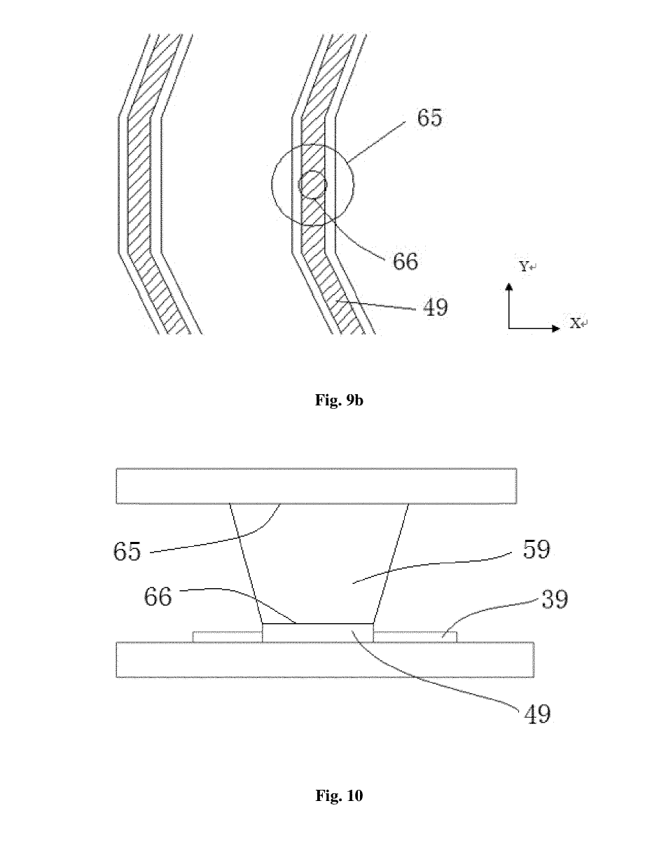

FIG. 9a shows a structure of a second embodiment of the present disclosure. FIG. 9a is a view when a panel is observed in a normal direction thereof, and FIG. 9b is an abbreviated drawing of FIG. 9a. FIG. 10 is a sectional view of the structure of the embodiment. The difference between embodiment 2 and embodiment 1 lies in that, in FIG. 10, a thickness of a conductive line 49 is larger than the first thickness in embodiment 1. Directions X and Y are respectively set in FIG. 9a. Along direction X, a width of a second contact surface 65 of the spacer is larger than that of a conductive line 49. An area of the second contact surface 65 is larger than that of the second contact surface in embodiment 1, so that the spacer 59 rides on the conductive line 49. As shown in FIG. 10, stability of the spacer 59 can be promoted. A contact area between the spacer 59 and the conductive line 49 is still equal to the contact area in embodiment 1. Since the thickness of the conductive line 49 is larger than the first thickness, a gap between a first contact surface 66 of the spacer 59 and a top surface of the alignment film 39 is increased. Therefore, when the panel is made thinner or is pressed, contact and friction between the spacer 59 and the alignment film 39 around the conductive line 49 can be avoided, and large-area non-uniform liquid crystal alignment can be avoided. An area of the black matrix arranged around the spacer 59 can be greatly reduced, and accordingly an aperture ratio of pixels can be improved.

The display device provided by the present disclosure comprises the in-cell touch panel in the embodiments.

Finally, it should be noted that, the above embodiments are only used for illustrating the technical solutions of the present disclosure and are not intended for limitations. Although the present disclosure is described in detail with reference to preferred embodiments, it can be understood by those skilled in the art that, any variations or equivalent replacements of the technical solutions of the present disclosure can be employed without departing from the spirit and scope of the present disclosure, which should be covered by the scope defined in the claims.

1. An in-cell touch panel, comprising a first substrate, a conductive line, a black matrix, a spacer, and a second substrate, wherein,
the first substrate and the second substrate are arranged facing each other;
the conductive line is arranged on a surface of the first substrate facing the second substrate;
a first contact surface of the spacer abuts against the conductive line, a second contact surface of the spacer abuts against the second substrate, a first projection is located inside the conductive line, and the first projection is a projection of the first contact surface on the conductive line; and
a second projection covers the conductive line, a boundary of the second projection is parallel to a boundary of the conductive line, and the second projection is a projection of the black matrix on the first substrate.

2. The in-cell touch panel according to claim 1, further comprising an alignment film, wherein the alignment film is arranged on a surface of the first substrate facing the second substrate and a surface of the second substrate facing the first substrate respectively, and the alignment film is disconnected at the conductive line.

3. The in-cell touch panel according to claim 2, wherein the first projection has a rectangular shape.

4. The in-cell touch panel according to claim 2, wherein the first projection has an oval shape.

5. The in-cell touch panel according to claim 2, wherein the first projection includes multiple same shapes.

6. The in-cell touch panel according to claim 5, wherein the shapes are round shapes or polygonal shapes.

7. The in-cell touch panel according to claim 2, wherein a thickness of the conductive line is a first thickness.

8. An in-cell touch panel, comprising a first substrate, a conductive line, a black matrix, a spacer, and a second substrate, wherein,
the first substrate and the second substrate are arranged facing each other;
the conductive line is arranged on the first substrate;
a first contact surface of the spacer abuts against the conductive line, a second contact surface of the spacer abuts against the second substrate, a first projection is located inside the conductive line, and the first projection is a projection of the first contact surface on the conductive line;
a second projection covers the conductive line, a boundary of the second projection is parallel to a boundary of the conductive line, and the second projection is a projection of the black matrix on the first substrate; and
a third projection includes the first projection, and the third projection is a projection of the second contact surface on the first substrate.

9. The in-cell touch panel according to claim 8, further comprising an alignment film, wherein the alignment film is arranged on a surface of the first substrate facing the second substrate and a surface of the second substrate facing the first substrate respectively, and the alignment film is disconnected at the conductive line.

10. A display device, comprising an in-cell touch panel, which comprises a first substrate, a conductive line, a black matrix, a spacer, and a second substrate, wherein,
the first substrate and the second substrate are arranged facing each other;
the conductive line is arranged on a surface of the first substrate facing the second substrate;
a first contact surface of the spacer abuts against the conductive line, a second contact surface of the spacer abuts against the second substrate, a first projection is located inside the conductive line, and the first projection is a projection of the first contact surface on the conductive line;
a second projection covers the conductive line, a boundary of the second projection is parallel to a boundary of the conductive line, and the second projection is a projection of the black matrix on the first substrate; and
wherein the in-cell touch panel further comprises an alignment film, which is arranged on a surface of the first substrate facing the second substrate and a surface of the second substrate facing the first substrate respectively, and the alignment film is disconnected at the conductive line.

11. The display device according to claim 10, wherein the first projection has a rectangular shape.

12. The display device according to claim 10, wherein the first projection has an oval shape.

13. The display device according to claim 10, wherein the first projection includes multiple same shapes.

14. The display device according to claim 10, wherein the shapes are round shapes or polygonal shapes.
